(19) United States
(12) Patent Application Publication
(10) Pub. No.: US 2010/0029538 A1
(43) Pub. Date: Feb. 4, 2010

(54) One-Step Treatment of Textiles

(76) Inventors: Anna-Liisa Auterinen, Espoo (FI); Ayrookaran J. Poulose, Belmont, CA (US); Mee-Young Yoon, Palo Alto, CA (US)

Correspondence Address: DANISCO US INC.;ATTENTION: LEGAL DEPARTMENT, 925 PAGE MILL ROAD, PALO ALTO, CA, 94304, US

(21) Appl. No.: 12/225,844

(22) PCT Filed: Apr. 10, 2007
(86) PCT No.: PCT/US2007/008957

§ 371 Date: Sep. 22, 2009

(30) Foreign Application Priority Data
Apr. 14, 2006 (US) 60/792111
May 30, 2006 (US) 10/581014

(51) Int. Cl. C11D 3/386

(52) U.S. Cl. 510/305

(57) ABSTRACT

The present invention is directed to novel compositions and methods for enzymatic one-step pretreatment of cellulosic, cellulosic-containing (e.g., cotton and cotton-containing) and non-cellulosic textiles, fibers and fabrics. Pretreatment comprises scouring and bleaching, and optionally, desizing of the textiles.

### CROSS-REFERENCE TO RELATED APPLICATIONS

The present application claims priority to currently pending U.S. Provisional Patent Application Ser. No. 60/792,111, filed Apr. 14, 2006. The present application is also a continuation-in-part of currently pending U.S. patent application Ser. No. 10/581,014 filed May 30, 2006, which claims priority under 35 U.S.C. §371 to PCT/US2004/040438, entitled “Perhydrolase”, filed Dec. 3, 2004, which claims priority under 35 U.S.C. §119 to U.S. Provisional Patent Application. Ser. No. 60/526,764, filed Dec. 3, 2003, now abandoned.

### FIELD OF THE INVENTION

This Invention relates to methods and compositions for the one-step enzymatic treatment for the desizing, scouring and bleaching of textiles.

### BACKGROUND OF THE INVENTION

In the textile processing of textile fibers, yarns and fabrics, a pretreatment or preparation step is typically required to properly prepare the natural materials for further use and in particular for the dyeing, printing and/or finishing stages typically required for commercial goods. These textile treatment steps remove impurities and color bodies, either naturally existing or those added by the spinning and weaving steps to the fibers and/or fabrics.

While textile treatments may include a number of varying treatments and stages, the most common include: de-sizing—the removal of sizing agents, such as starches, via enzymatic, alkali or oxidative soaking; scouring—the removal of greases, oils, waxes, pectic substances, motes, protein and fats by contact with a solution of sodium hydroxide at temperatures near boiling; and bleaching—the removal and lightening of color bodies from textiles by commonly using oxidizing agents (such as hydrogen peroxide, hypochlorite, and chlorine dioxide), or by using reducing agents (such as, sulfur dioxide or hydrosulfite salts).

Commercial enzymatic textile processing typically requires the separation of these pretreatment steps due to the broad variation of conditions present in each of the steps. However, this separation of treatment steps leads to heavy additional costs added to the overall treatment process due to the use of several consecutive baths with varying pH and temperature conditions and chemical additions, and the requirement of multiple rinsing steps between the respective stages, and high energy costs due to high processing temperature above 95° C. The additional rinse and/or drying steps add enormous additional costs and waste materials to the treatment process.

Accordingly, the combination of various pre-treatment stages into a one-step treatment would have a significant impact in the commercial treatment of textiles in the form of reduced costs and waste materials over the commercial processes typically employed.

However, the combination of these three common steps, while previously investigated, has been unsatisfactory. Currently employed bleaching technology involves the use of alkaline hydrogen peroxide bleaching at temperatures in excess of 95° C. Such high temperatures and strong bleaching systems are wholly incompatible with the amylase enzymes necessary in a de-sizing operation. Thus, the combination of the de-sizing and bleaching technology at temperatures in excess of 95° C. leads to destruction of the de-sizing enzymes and an unsatisfactory de-sizing result. Alternative de-sizing techniques such as alkali or oxidative soaking involve the use of aggressive chemicals which lead to fiber damage. On the other hand, reduction of the temperature at which the one-step treatment is conducted to allow effective enzymatic de-sizing results in an unacceptably poor bleaching with whiteness values below the commercially acceptable limit. Furthermore, this kind of low temperature process without a scouring enzyme produces a fabric of low wettability that is unacceptable for further dyeing, printing and finishing processes.

US2002-0007516 discloses a one-step process that uses a hydrophobic bleach activator or pre-formed peracid in conjunction with hydrogen peroxide. However, this technology still requires a chemical entity that necessitates additional processing of the waste stream resulting in increased costs to the textile processor. Similarly, US2003041387 discloses the use of a bleaching system that utilizes a peracid that is added as a component and not generated in situ.

None of these systems rely on enzymatic compositions for the simultaneous desizing, scouring and bleaching of cotton and cotton-based textiles and non-cotton cellulosic textiles nor do they provide an environmentally friendly enzymatic process for such a one-step process of textiles. Although they may be an improvement over conventional methods, they still leave much room for improvement.

Accordingly, the need remains for an effective enzymatic one step textile treatment process and in particular for the combination of de-sizing, scouring and bleaching in textile treatment which can provide superior wettability and whiteness benefits while minimizing the environmental footprint and costs to the textile mills and providing improved fabric strength retention and reduced fiber damage versus conventional textile bleaching processes.

### BRIEF SUMMARY OF THE INVENTION

Applicants describe herein methods and compositions for the one-step enzymatic treatment of textiles. In one aspect, there are provided methods for the enzymatic bleaching of textiles. In a second aspect, there are provided methods for the treatment of textiles with a one-step treatment composition. In a third aspect, there are provided compositions for the one-step treatment for the desizing, scouring and bleaching of textiles. In an aspect, a composition for the enzymatic bleaching of a textile is provided. In an aspect, the treatment of textiles is for the desizing and/or scouring and/or bleaching of textiles. Textiles that can be treated by the methods and compositions described herein are cellulosic or cellulosic-containing textiles, such as cotton and cotton blends, but the treatment is not limited to cellulosics.

In an embodiment, the method comprises the enzymatic bleaching of textiles by contacting a textile in need of bleaching with an enzymatic bleaching composition comprising an ester source, an acyl transferase, and a hydrogen peroxide source for a length of time and under conditions suitable to permit the measurable whitening of the textile. The ester source may be any suitable acetate ester. The ester source is present in the bleaching liquor at a concentration of between about 100 ppm to 10,000 ppm, between about 1000 ppm to 5000 ppm or between about 2000 ppm to 4000 ppm.

A suitable acetate ester is selected from propylene glycol diacetate, ethylene glycol diacetate, triacetin, ethyl acetate, tributyrin and the like. Combinations of the foregoing acetate esters are also contemplated.

The acyl transferase may be any transferase that has a perhydrolysis to hydrolysis ratio that is greater than 1. The concentration of the acyl transferase in the bleaching liquor is between about 0.005 ppm to 100 ppm, between about 0.01 to 50 ppm or between 0.05 to 10 ppm.

The hydrogen peroxide may be added from an exogenous source. Alternatively, the hydrogen peroxide can be enzymatically generated in situ by a hydrogen peroxide generating oxidase and a suitable substrate. The hydrogen peroxide generating oxidase can be a carbohydrate oxidase such as glucose oxidase. The suitable substrate can be glucose. The concentration of the hydrogen peroxide in the bleaching liquor is between about 100 to 5000 ppm, a concentration of between about 500 to 4000 ppm or a concentration of between about 1000 to 3000 ppm.

The suitable conditions will depend on the enzymes and processing method (e.g., continuous vs batch vs pad-batch) used but is contemplated to comprise varying temperatures, pHs, processing time and the like.

Suitable pH conditions comprise a pH of between about 5-11, a pH between about 6 and 10, and a pH between 6 and 8. Suitable time conditions for the enzymatic bleaching of the textile are between about preferably 5 minutes and 24 hours, a time between about 15 minutes and 12 hours, or a time between about 30 minutes and 6 hours.

Suitable temperature conditions comprise a temperature of between about 15° C. and 90° C., a temperature of between about 24° C. and 80° C. or a temperature of between about 40° C. and 60° C.

In an embodiment, methods for the treatment of textiles with a one-step treatment composition comprise contacting a textile in need of processing with a one-step treatment composition for a length of time and under conditions sufficient to permit desizing, scouring and bleaching of the textile.

The one-step treatment composition preferably comprises i) one or more bioscouring enzymes, ii) one or more desizing enzymes and iii) one or more enzymatic bleaching system. The one-step treatment composition may further comprise one or more auxiliary components selected from surfactants, emulsifiers, chelating agents and/or stabilizers.

The enzymatic bleaching system, the suitable conditions and length of time for this embodiment are as described for the first embodiment.

The bioscouring enzyme is a pectinase, which includes but is not limited to pectate lyases, pectin esterases, polygalacturonases, etc. as described by J. R. Whitaker (Microbial pectolytic enzymes, (1990) p. 133-176. In W. M. Fogarty and C. T. Kelly (ed.), Microbial enzymes and biotechnology. Elsevier Science Publishers, Barking, United Kingdom) or combination of pectinase and other enzymes such as cutinases, cellulases, proteases, lipases, and hemicellulases. In one embodiment, the pectinase is a pectate lyase.

The desizing enzyme is selected from a group consisting of amylases and mannanases. A specific amylase that finds use as a desizing enzyme is an alpha-amylase.

The one-step treatment composition may further comprise auxiliary components selected from surfactants, emulsifiers, chelating agents, and/or stabilizers. The surfactant may be a non-ionic surfactant or a combination of non-ionic and anionic surfactants.

A chemical bleaching agent may be used in conjunction with the one-step treatment composition. Suitable chemical bleaching agent(s) may be selected from oxidative bleaches, sodium peroxide, sodium perborate, otasium permanganate, sodium hypochlorite, calcium hypochlorite and sodium dichloroisocyanurate.

In a composition embodiment, the one-step treatment composition comprises i) one or more bioscouring enzymes and ii) an enzymatic bleaching system. In one aspect the composition may include one or more desizing enzymes. The one-step treatment composition may further comprise one or more auxiliary components selected from surfactants, emulsifiers, chelating agents and/or stabilizers.

Other objects, features and advantages of the present invention will become apparent from the following detailed description. It should be understood, however, that the detailed description and specific examples, while indicating preferred embodiments of the invention, are given by way of illustration only, since various changes and modifications within the scope and spirit of the invention will become apparent to one skilled in the art from this detailed description.

### BRIEF DESCRIPTION OF THE DRAWINGS

FIG. 1 illustrates the bleaching effects of various treatments. Pictures of swatches after treatments with A) buffer, B) buffer+surfactant+PGDA+H₂O₂, C) buffer+surfactant+BP 3000 L and D) buffer+surfactant+PGDA+H₂O₂+AcT+OxAm+BP 3000 L+cutinase.

FIG. 2 shows pictures of swatches taken after 12 hour pad-batch treatment with Control (top two swatches) and Control+enzyme (bottom two swatches).

FIG. 3 shows swatches just after iodine staining: A) buffer, B) Buffer+surfactant+PGDA+H₂O₂, C) buffer+surfactant+OxAm. D) buffer+surfactant+PGDA+H₂O₂+enzyme mixtures, E) commercially bleached cotton (positive control), F) buffer+surfactant+PGDA+H₂O₂ (pad-batch), G) buffer+surfactant+PGDA+H₂O₂+Enzyme mixtures (pad-batch).

FIG. 4 shows pictures of swatches after Ruthenium Red staining: A) commercially bleached cotton (positive control) B) buffer, C) buffer+surfactant+BP 3000 L. D) Buffer+surfactant+PGDA+H₂O₂, E) buffer+surfactant+PGDA+H₂O₂+enzyme mixture, F) buffer+surfactant+PGDA+H₂O₂+(pad-batch), G) buffer+surfactant+PGDA+H₂O₂+enzyme mixture (pad-batch).

FIG. 5 provides a graph showing the bleaching ability of the AcT tested on cotton.

FIG. 6 provides a graph showing the bleaching ability of the AcT tested on linen

### DETAILED DESCRIPTION

The invention will now be described in detail by way of reference only using the following definitions and examples. All patents and publications, including all sequences disclosed within such patents and publications, referred to herein are expressly incorporated by reference.

Numeric ranges are inclusive of the numbers defining the range.

Unless otherwise indicated, nucleic acids are written left to right in 5′ to 3′ orientation; amino acid sequences are written left to right in amino to carboxy orientation, respectively.

The headings provided herein are not limitations of the various aspects or embodiments of the invention which can be had by reference to the specification as a whole. Accordingly, the terms defined immediately below are more fully defined by reference to the specification as a whole.

### Definitions

Unless defined otherwise herein, all technical and scientific terms used herein have the same meaning as commonly understood by one of ordinary skill in the art to which this invention pertains. For example, Singleton and Sainsbury, Dictionary of Microbiology and Molecular Biology, 2d Ed., John Wiley and Sons, NY (1994); and Hale and Marham, The Harper Collins Dictionary of Biology, Harper Perennial, NY (1991) provide those of skill in the art with a general dictionary of many of the terms used in the invention. Although any methods and materials similar or equivalent to those described herein find use in the practice of the present invention, the preferred methods and materials are described herein. Accordingly, the terms defined immediately below are more fully described by reference to the Specification as a whole. Also, as used herein, the singular terms “a”, “an,” and “the” include the plural reference unless the context clearly indicates otherwise. Unless otherwise indicated, nucleic acids are written left to right in 5′ to 3′ orientation; amino acid sequences are written left to right in amino to carboxy orientation, respectively. It is to be understood that this invention is not limited to the particular methodology, protocols, and reagents described, as these may vary, depending upon the context they are used by those of skill in the art.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The term “bleaching,” as used herein, means the process of treating textile materials such as a fiber, yarn, fabric, garment and non-wovens to produce a lighter color in said fiber, yarn, fabric, garment or non-wovens. For example, bleaching as used herein means the whitening of the fabric by removal, modification or masking of color causing compounds in cellulosic or other textile materials. Thus, “bleaching” refers to the treatment of a textile for a sufficient length of time and under appropriate pH and temperature conditions to effect a brightening (i.e., whitening) of the textile. Bleaching may be performed using chemical bleaching agent and/or enzymatically generated bleaching agents. Examples of suitable bleaching agents include but are not limited to ClO₂, H₂O₂, peracids, NO₂, etc. In the present processes, methods and compositions. H₂O₂ and peracids are preferably generated enzymatically.

The term “bleaching agent” as used herein encompasses any moiety that is capable of bleaching fabrics.

“Chemical bleaching agent(s)” are entities that are capable of bleaching a textile without the presence of an enzyme. They may require the presence of a bleach activator. Examples of suitable chemical bleaching agents useful in the processes, methods and compositions described herein are sodium peroxide, sodium perborate, potassium permanganate, other peracids. In some aspects, H₂O₂ may be considered a chemical bleaching agent when it has not been generated enzymatically in situ.

The term “one-step textile processing composition” refers to a preparation comprising at least one bioscouring enzyme and at least one enzymatically generated bleaching agent. In some embodiments, the processing composition further comprises at least one desizing enzyme. The enzymatically generated bleaching agent is preferably a peracid. In one aspect the peracid is generated by the catalytic action of an acyl transferase on a suitable substrate in the presence of hydrogen peroxide. The one-step textile processing composition will contain sufficient enzymes to provide the enzyme levels provided for herein in the treatment liquor, i.e., the aqueous medium. Enzymes useful herein are wild-type enzymes as well as variants thereof. Preferably the variants have been engineered to be oxidatively stable, e.g, stable in the presence of hydrogen peroxide.

The phrase “enzymatic bleaching system” means enzymes and substrates capable of enzymatically generating a bleaching agent. An enzymatic bleaching system may comprise an ester source, an acyl transferase (or perhydrolase) and a hydrogen peroxide source.

“Ester source” refers to perhydrolase substrates that contain an ester linkage. Esters comprising aliphatic and/or aromatic carboxylic acids and alcohols are utilized with the perhydrolase enzymes. In preferred embodiments, the ester source is an acetate ester. In some preferred embodiments, the ester source is selected from one or more of propylene glycol diacetate, ethylene glycol diacetate, triacetin, ethyl acetate and tributyrin. In some preferred embodiments, the ester sources are selected from the esters of one or more of the following acids: formic acid, acetic acid, propionic acid, butyric acid, valeric acid, caproic acid, caprylic acid, nonanoic acid, decanoic acid, dodecanoic acid, myristic acid, palmitic acid, stearic acid, and oleic acid.

The term “hydrogen peroxide source” means hydrogen peroxide that is added to the textile treatment bath either from an exogenous (i.e., an external or outside) source or generated in situ by the action of an hydrogen peroxide generating oxidase on a its substrate.

The term “hydrogen peroxide generating oxidase” means an enzyme that catalyzes an oxidation/reduction reaction involving molecular oxygen (O₂) as the electron acceptor. In these reactions, oxygen is reduced to water (H₂O) or hydrogen peroxide (H₂O₂). Oxidases suitable for use herein are the oxidases that generate hydrogen peroxide (as opposed to water) on its substrate. An example of a hydrogen peroxide generating oxidase and its substrate suitable for use herein would be glucose oxidase and glucose. Other enzymes (e.g., alcohol oxidase, ethylene glycol oxidase, glycerol oxidase, amino acid oxidase, etc.) that can generate hydrogen peroxide also find use with ester substrates in combination with the perhydrolase enzymes of the present invention to generate peracids. In some embodiments, the hydrogen peroxide generating oxidase is a carbohydrate oxidase.

As used herein, the terms “perhydrolase” and “acyl transferase” are used interchangeably and refer to an enzyme that is capable of catalyzing a reaction that results in the formation of sufficiently high amounts of peracid suitable for bleaching. In particularly preferred embodiments, the perhydrolase enzymes useful in the processes, methods and compositions described herein produce very high perhydrolysis to hydrolysis ratios. The high perhydrolysis to hydrolysis ratios of these distinct enzymes makes these enzymes suitable for use in the processes, methods and compositions described herein. In particularly preferred embodiments, the perhydrolases are those described in WO 05/056782. However, it is not intended that the present processes, methods and compositions be limited to this specific M. smegmatis perhydrolase, specific variants of this perhydrolase, nor specific homologs of this perhydrolase.

As used herein, the phrase “perhydrolysis to hydrolysis ratio” is the ratio of the amount of enzymatically produced peracid to that of enzymatically produced acid by the perhydrolase, under defined conditions and within a defined time. In some preferred embodiments, the assays provided in WO 05/056782 are used to determine the amounts of peracid and acid produced by the enzyme.

As used herein, “textile” refers fibers, yarns, fabrics, garments, and non-wovens. The term encompasses textiles made from natural, synthetic (e.g., manufactured), and various natural and synthetic blends. Thus, the term “textile(s)” refers to unprocessed and processed fibers, yarns, woven or knit fabrics, non-wovens, and garments. In the present specification, the terms “textile(s),” “fabric(s)” and “garment(s)” will be interchangeable unless expressly provided otherwise. The term “textile(s) in need of processing” refers to textiles that need to be desized and/or scoured and/or bleached or may be in need of other treatments such as biopolishing.

The term “textile(s) in need of bleaching” refers to textiles that need to be bleached without reference to other possible treatments. These textiles may or may not have been already subjected to other treatments. Similarly, these textiles may or may not need subsequent treatments.

As used herein, “textile materials” is a general term for fibers, yarn intermediates, yarns, fabrics, products made from fabrics (e.g., garments and other articles) and non-wovens.

As used herein, the term “compatible,” means that the components of a one-step textile processing composition do not reduce the enzymatic activity of the perhydrolase to such an extent that the perhydrolase is not effective as desired during normal use situations. Specific composition materials are exemplified in detail hereinafter.

As used herein, “effective amount of perhydrolase enzyme” refers to the quantity of perhydrolase enzyme necessary to achieve the enzymatic activity required in the processes or methods described herein. Such effective amounts are readily ascertained by one of ordinary skill in the art and are based on many factors, such as the particular enzyme variant used, the pH used, the temperature used and the like, as well as the results desired (e.g., level of whiteness).

As used herein, “oxidizing chemical” refers to a chemical that has the capability of bleaching a textile. The oxidizing chemical is present at an amount, pH and temperature suitable for bleaching. The term includes, but is not limited to hydrogen peroxide and peracids.

As used herein, “acyl” is the general name for organic acid groups, which are the residues of carboxylic acids after removal of the —OH group (e.g., ethanoyl chloride, CH₃CO—Cl, is the acyl chloride formed from ethanoic acid, CH₃COO—H). The names of the individual acyl groups are formed by replacing the “-ic” of the acid by “-yl.”

As used herein, the term “transferase” refers to an enzyme that catalyzes the transfer of functional compounds to a range of substrates.

As used herein, the term “enzymatic conversion” refers to the modification of a substrate to an intermediate or the modification of an intermediate to an end-product by contacting the substrate or intermediate with an enzyme. In some embodiments, contact is made by directly exposing the substrate or intermediate to the appropriate enzyme. Thus, the production of hydrogen peroxide by, for example, glucose oxidase results from the enzymatic conversion of glucose to gluconic acid in the presence of oxygen. Similarly, for example, a peracid can be generated by the enzymatic conversion of an ester by an acyl transferase in the presence of hydrogen peroxide.

As used herein, the phrase, “stability to proteolysis” refers to the ability of a protein (e.g., an enzyme) to withstand proteolysis. It is not intended that the term be limited to the use of any particular protease to assess the stability of a protein.

As used herein, “oxidative stability” refers to the ability of a protein to function under oxidative conditions. In particular, the term refers to the ability of a protein to function in the presence of various concentrations of H₂O₂ and/or peracid. Stability under various oxidative conditions can be measured either by standard procedures known to those in the art and/or by the methods described herein. A substantial change in oxidative stability is evidenced by at least about a 5% or greater increase or decrease (in most embodiments, it is preferably an increase) in the half-life of the enzymatic activity, as compared to the enzymatic activity present in the absence of oxidative compounds.

As used herein, “pH stability” refers to the ability of a protein to function at a particular pH. In general, most enzymes have a finite pH range at which they will function. In addition to enzymes that function in mid-range pHs (i.e., around pH 7), there are enzymes that are capable of working under conditions with very high or very low pHs. Stability at various pHs can be measured either by standard procedures known to those in the art and/or by the methods described herein. A substantial change in pH stability is evidenced by at least about 5% or greater increase or decrease (in most embodiments, it is preferably an increase) in the half-life of the enzymatic activity, as compared to the enzymatic activity at the enzyme's optimum pH. However, it is not intended that the present processes, methods and/or compositions described herein be limited to any pH stability level nor pH range.

As used herein, “thermal stability” refers to the ability of a protein to function at a particular temperature. In general, most enzymes have a finite range of temperatures at which they will function. In addition to enzymes that work in mid-range temperatures (e.g., room temperature), there are enzymes that are capable of working in very high or very low temperatures. Thermal stability can be measured either by known procedures or by the methods described herein. A substantial change in thermal stability is evidenced by at least about 5% or greater increase or decrease (in most embodiments, it is preferably an increase) in the half-life of the catalytic activity of a mutant when exposed to a different temperature (i.e., higher or lower) than optimum temperature for enzymatic activity. However, it is not intended that the processes, methods and/or compositions described herein be limited to any temperature stability level nor temperature range.

As used herein, the term “chemical stability” refers to the stability of a protein (e.g., an enzyme) towards chemicals that adversely affect its activity. In some embodiments, such chemicals include, but are not limited to hydrogen peroxide, peracids, anionic surfactants, cationic surfactants, non-ionic surfactants, chelants, etc. However, it is not intended that the processes, methods and/or compositions described herein be limited to any particular chemical stability level nor range of chemical stability.

As used herein, the terms “purified” and “isolated” refer to the removal of contaminants from a sample. For example, perhydrolases are purified by removal of contaminating proteins and other compounds within a solution or preparation that are not perhydrolases. In some embodiments, recombinant perhydrolases are expressed in bacterial or fungal host cells and these recombinant perhydrolases are purified by the removal of other host cell constituents; the percent of recombinant perhydrolase polypeptides is thereby increased in the sample.

As used herein, “protein” refers to any composition comprised of amino acids and recognized as a protein by those of skill in the art. The terms “protein,” “peptide” and polypeptide are used interchangeably herein. Wherein a peptide is a portion of a protein, those skilled in the art understand the use of the term in context.

As used herein, functionally and/or structurally similar proteins are considered to be “related proteins.” In some embodiments, these proteins are derived from a different genus and/or species, including differences between classes of organisms (e.g., a bacterial protein and a fungal protein). In some embodiments, these proteins are derived from a different genus and/or species, including differences between classes of organisms (e.g., a bacterial enzyme and a fungal enzyme). In additional embodiments, related proteins are provided from the same species. Indeed, it is not intended that the processes, methods and/or compositions described herein be limited to related proteins from any particular source(s). In addition, the term “related proteins” encompasses tertiary structural homologs and primary sequence homologs. In further embodiments, the term encompasses proteins that are immunologically cross-reactive.

In most particularly preferred embodiments, the related perhydrolase proteins useful herein have very high ratios of perhydrolysis to hydrolysis.

As used herein, the term “derivative” refers to a protein which is derived from a protein by addition of one or more amino acids to either or both the C- and N-terminal end(s). substitution of one or more amino acids at one or a number of different sites in the amino acid sequence, and/or deletion of one or more amino acids at either or both ends of the protein or at one or more sites in the amino acid sequence, and/or insertion of one or more amino acids at one or more sites in the amino acid sequence. The preparation of a protein derivative is preferably achieved by modifying a DNA sequence which encodes for the native protein, transformation of that DNA sequence into a suitable host, and expression of the modified DNA sequence to form the derivative protein.

Related (and derivative) proteins comprise “variant proteins.” In some preferred embodiments, variant proteins differ from a parent protein, e.g., a wild-type protein, and one another by a small number of amino acid residues. The number of differing amino acid residues may be one or more, preferably 1, 2, 3, 4, 5, 10, 15, 20, 30, 40, 50, or more amino acid residues. The number of different amino acids between variants is between 1 and 10. In some aspects, related proteins and particularly variant proteins comprise at least 35%, 40%, 45%, 50%, 55%, 60%, 65%, 70%, 75%, 80%, 85%, 90%, 95%, 97%, 98%, or 99% amino acid sequence identity. Additionally, a related protein or a variant protein as used herein, refers to a protein that differs from another related protein or a parent protein in the number of prominent regions. For example, in some embodiments, variant proteins have 1, 2, 3, 4, 5, or 10 corresponding prominent regions that differ from the parent protein.

Several methods are known in the art that are suitable for generating variants of the enzymes described herein, including but not limited to site-saturation mutagenesis, scanning mutagenesis, insertional mutagenesis, random mutagenesis, site-directed mutagenesis, and directed-evolution, as well as various other recombinatorial approaches.

In particularly preferred embodiments, homologous proteins are engineered to produce enzymes with the desired activity(ies).

As used herein, the term “analogous sequence” refers to a sequence within a protein that provides similar function, tertiary structure, and/or conserved residues as the protein of interest (i.e., typically the original protein of interest). For example, in epitope regions that contain an alpha helix or a beta sheet structure, the replacement amino acids in the analogous sequence preferably maintain the same specific structure. The term also refers to nucleotide sequences, as well as amino acid sequences. In some embodiments, analogous sequences are developed such that the replacement amino acids result in a variant enzyme showing a similar or improved function. In some preferred embodiments, the tertiary structure and/or conserved residues of the amino acids in the protein of interest are located at or near the segment or fragment of interest. Thus, where the segment or fragment of interest contains, for example, an alpha-helix or a betasheet structure, the replacement amino acids preferably maintain that specific structure.

As used herein, “homologous protein” refers to a protein (e.g., perhydrolase) that has similar action and/or structure, as a protein of interest (e.g., an perhydrolase from another source). It is not intended that homologs be necessarily related evolutionarily. Thus, it is intended that the term encompass the same or similar enzyme(s) (i.e., in terms of structure and function) obtained from different species. In some preferred embodiments, it is desirable to identify a homolog that has a quaternary, tertiary and/or primary structure similar to the protein of interest, as replacement for the segment or fragment in the protein of interest with an analogous segment from the homolog will reduce the disruptiveness of the change. In some embodiments, homologous proteins have induce similar immunological response(s) as a protein of interest.

As used herein, “wild-type” and “native” proteins are those found in nature. The terms “wild-type sequence,” and “wild-type gene” are used interchangeably herein, to refer to a sequence that is native or naturally occurring in a host cell. In some embodiments, the wild type sequence refers to a sequence of interest that is the starting point of a protein engineering project. The genes encoding the naturally-occurring protein may be obtained in accord with the general methods known to those skilled. In the art. The methods generally comprise synthesizing labeled probes having putative sequences encoding regions of the protein of interest, preparing genomic libraries from organisms expressing the protein, and screening the libraries for the gene of interest by hybridization to the probes. Positively hybridizing clones are then mapped and sequenced.

The degree of homology between sequences may be determined using any suitable method known in the art (See e.g., Smith and Waterman, Adv. Appl. Math., 2:482 [1981]; Needleman and Wunsch, J. Mol. Biol., 48:443 [1970]; Pearson and Lipman, Proc. Natl. Acad. Sci. USA 85:2444 [1988]; programs such as GAP, BESTFIT, FASTA, and TFASTA in the Wisconsin Genetics Software Package (Genetics Computer Group, Madison, Wis.); and Devereux et al., Nucl. Acid Res., 12:387-395 [1984]).

For example, PILEUP is a useful program to determine sequence homology levels. PILEUP creates a multiple sequence alignment from a group of related sequences using progressive, pairwise alignments. It can also plot a tree showing the clustering relationships used to create the alignment. PILEUP uses a simplification of the progressive alignment method of Feng and Doolittle, (Feng and Doolittle, J. Mol. Evol., 35:351-360 [1987]). The method is similar to that described by Higgins and Sharp (Higgins and Sharp, CABIOS 5:151-153 [1989]). Useful PILEUP parameters including a default gap weight of 3.00, a default gap length weight of 0.10, and weighted end gaps. Another example of a useful algorithm is the BLAST algorithm, described by Altschul et al., (Altschul et al., J. Mol. Biol., 215:403-410, [1990]; and Karlin et al., Proc. Natl. Acad. Sci. USA 90:5873-5787 [1993]). One particularly useful BLAST program is the WU-BLAST-2 program (See, Altschul et al., Meth. Enzymol., 266:460-480 [1996]). parameters “W,” “T,” and “X” determine the sensitivity and speed of the alignment. The BLAST program uses as defaults a wordlength (W) of 11, the BLOSUM62 scoring matrix (See, Henikoff and Henikoff, Proc. Natl. Acad. Sci. USA 89:10915 [1989]) alignments (B) of 50, expectation (E) of 10, M′5, N′−4, and a comparison of both strands.

The phrases “substantially similar and “substantially identical” in the context of at least two nucleic acids or polypeptides typically means that a polynucleotide or polypeptide comprises a sequence that has at least about 40% identity, more preferable at least about 50% identity, yet more preferably at least about 60% identity, preferably at least about 75% identity, more preferably at least about 80% identity, yet more preferably at least about 90%, still more preferably about 95%, most preferably about 97% identity, sometimes as much as about 98% and about 99% sequence identity, compared to the reference (i.e., wild-type) sequence. Sequence identity may be determined using known programs such as BLAST, ALIGN, and CLUSTAL using standard parameters. (See e.g., Altschul, et al., J. Mol. Biol. 215:403-410 [1990]; Henikoff et al., Proc. Natl. Acad. Sci. USA 89:10915 [1989]; Karin et al., Proc. Natl. Acad. Sci. USA 90:5873 [1993]; and Higgins et al., Gene 73:237-244 [1988]). Software for performing BLAST analyses is publicly available through the National Center for Biotechnology Information. Also, databases may be searched using FASTA (Pearson et al., Proc. Natl. Acad. Sci. USA 85:2444-2448 [1988]). One indication that two polypeptides are substantially identical is that the first polypeptide is immunologically cross-reactive with the second polypeptide. Typically, polypeptides that differ by conservative amino acid substitutions are immunologically cross-reactive. Thus, a polypeptide is substantially identical to a second polypeptide, for example, where the two peptides differ only by a conservative substitution. Another indication that two nucleic acid sequences are substantially identical is that the two molecules hybridize to each other under stringent conditions (e.g., within a range of medium to high stringency).

The term “simultaneously” or “simultaneous” or “one-step” are intended to indicate that at least a portion (e.g., preferably about 75% or more, more preferably about 90% or more) of the desizing, scouring and bleaching are carried out in a single operation. The term is not intended to mean that the textiles treated by the methods and compositions can not be treated more than once. Rather, the term means that for each treatment cycle, multiple components, as detailed elsewhere in this application, are used in processing the textile at one time. Likewise, the components of the treatment may be added one at a time, all at once or in groups providing that for at least a portion of the treatment cycle all of the components are present. The portion of the treatment cycle in which all of the components are present may vary depending on the total length of the treatment cycle.

The term “simultaneously” is also intended to indicate in some embodiments that at least a portion of the bioscouring and enzymatic bleaching are carried out in a single operation. This has the obvious advantage that the washing and other treatments normally performed between separately conducted scouring and bleaching steps are no longer required. Thereby, the water, time and energy demand as well as the demand to different equipment to be used for each of the processes are considerably reduced. Furthermore, depending on the type of fabric to be treated and the nature of impurities present thereon, a desizing effect may be obtained during the performance of the process of the invention. Thus, in such cases, no additional desizing treatment needs to be performed. While it is preferred that all de-sizing be carried out in conjunction with the bleaching step, one of ordinary skill in the art will recognize that some portion of de-sizing may be carried out separately from the bleaching step without departing from the spirit of the invention.

A “purified preparation” or a “substantially pure preparation” of a polypeptide (such as an enzyme), as used herein, means a polypeptide that has been separated from other proteins, lipids, and nucleic acids with which it naturally occurs. Preferably, the polypeptide is also separated from substances, e.g., antibodies or gel matrix (e.g., polyacrylamide), which are used to purify it. Preferably, the polypeptide constitutes at least 10, 20, 50 70, 80 or 95% dry weight of the purified preparation. The enzymes may be used or supplied in some embodiments as a purified preparation.

The terms “peptides,” “proteins” and “polypeptides” are used interchangeably herein. “Enzymes” are a type of protein that are capable of catalyzing biochemical reactions. In the present processes, methods and compositions, the enzymes are predominantly enzymes capable of breaking down (i.e., degrading) various natural substances such as, but not limited to, proteins and carbohydrates.

The terms “size” or “sizing” refer to compounds used in the textile industry to improve weaving performance by increasing the abrasion resistance and strength of the yarn. Size is usually made of, for example, starch or starch-like compounds.

The terms “desize” or “desizing,” as used herein, refer to the process of eliminating size, generally starch, from textiles usually prior to applying special finishes, dyes or bleaches.

“Desizing enzyme(s)” as used herein refer to enzymes that are used to enzymatically remove the size. Exemplary enzymes are amylases, cellulases and mannanases.

The term “perhydrolyzation” or “perhydrolyzed,” as used herein refer to a reaction wherein peracetic acid is generated from ester substrates in the presence of hydrogen peroxide. In a preferred embodiment, the perhydrolyzation reaction is catalyzed with the enzyme acyl transferase.

The term “peracetic acid,” as used herein, refers to a peracid derived from the ester groups of a donor molecule. In general, a peracid is derived from a carboxylic acid ester which has been reacted with hydrogen peroxide to form a highly reactive peracid product that is able to transfer one of its oxygen atoms. It is this ability to transfer oxygen atoms that enables peracetic acid to function as a bleaching agent.

The term “scouring,” as used herein, means to remove impurities, for example, much of the non-cellulosic compounds (e.g., pectins, proteins, wax, and motes. etc) naturally found in cotton or other textiles. In addition to the natural non-cellulosic impurities, scouring can remove, in some embodiments, residual manufacturing introduced materials such as spinning, coning or slashing lubricants.

The term “bioscouring enzyme(s)” therefore refers to an enzyme(s) capable of removing at least a portion of the impurities found in cotton or other textiles.

The term “motes” refers to unwanted impurities, such as cotton seed fragments, leaves, stems and other plant parts, which cling to the fiber even after mechanical ginning process.

The term “greige” (pronounced gray) textiles, as used herein, refer to textiles that have not received any bleaching, dyeing or finishing treatment after being produced. For example, any woven or knit fabric off the loom that has not yet been finished (desized, scoured, etc.), bleached or dyed is termed a greige textile. The textiles used in the examples, infra, are greige textiles.

The term “dyeing,” as used herein, refers to applying a color, especially by soaking in a coloring solution, to, for example, textiles.

The term “non-cotton cellulosic” fibers, yarn or fabric means fibers, yarns or fabrics which are comprised primarily of a cellulose based composition other than cotton. Examples of such compositions include linen, ramie, jute, flax, rayon, lyocell, cellulose acetate and other similar compositions which are derived from non-cotton cellulosics.

The term “protease” means a protein or polypeptide domain of a protein or polypeptide derived from a microorganism, e.g. a fungus, bacterium, or from a plant or animal, and that has the ability to catalyze cleavage of peptide bonds at one or more of various positions of a protein carbohydrate backbone.

The term “acyl transferase,” as used herein, refers to enzymes functional in the breakdown of esters and other oil-based compositions need to be removed in the processing (e.g., the scouring) of textiles. Acyl transferase, in the composition context, refers to enzymes that catalyze the conversion of suitable compounds (e.g., propylene glycol diacetate) into various components including peracetic acid.

The term “cutinase,” as used herein, refers to as a plant, bacterial or fungal derived enzyme used in textile processing. Cutinases are lipolytic enzymes capable of hydrolyzing the substrate cutin. Cutinases can breakdown fatty acid esters and other oil-based compositions need to be removed in the processing (e.g., the scouring) of textiles. “Cutinase” means an enzyme that has significant plant cutin hydrolysis activity. Specifically, a cutinase will have hydrolytic activity on the biopolyester polymer cutin found on the leaves of plants. Suitable cutinases may be isolated from many different plant, fungal and bacterial sources. Examples of cutinases are provided in Lipases: Structure, Mechanism and Genetic Engineering, VCH Publishers, edited by Alberghina, Schmid & Verger (1991) pp. 71-77; Upases, Elsevier, edited by Borgstrom & Brockman (1984) pp. 471-477; and Sebastian et al., J. Bacteriology, vol. 169, no. 1, pp. 131-136 (1987).

The term “pectate lyase,” as used herein, refers to a type of pectinase. “Pectinase” denotes a pectinase enzyme defined according to the art where pectinases are a group of enzymes that cleave glycosidic linkages of pectic substances mainly poly(1,4-alpha-D-galacturonide and its derivatives (see reference Sakai et al., Pectin, pectinase and protopectinase: production, properties and applications, pp 213-294 in: Advances in Applied Microbiology vol:39, 1993). Preferably a pectinase useful herein is a pectinase enzyme which catalyzes the random cleavage of alpha-1,4-glycosidic linkages in pectic acid also called polygalacturonic acid by transelimination such as the enzyme class polygalacturonate lyase (EC 4.2.2.2) (PGL) also known as poly(1,4-alpha-D-galacturonide) lyase also known as pectate lyase.

The term “pectin” denotes pectate, polygalacturonic acid and pectin which may be esterified to a higher or lower degree.

The term “α-amylase,” as used herein, refers to an enzyme that cleaves the α(1-4)glycosidic linkages of amylose to yield maltose molecules (disaccharides of α-glucose). Amylases are digestive enzymes found in saliva and are also produced by many plants. Amylases break down long-chain carbohydrates (such as starch) into smaller units. An “oxidative stable” α-amylase is an α-amylase that is resistive to degradation by oxidative means, when compared to non-oxidative stable α-amylase, especially when compared to the non-oxidative stable α-amylase form which the oxidative stable α-amylase was derived.

As used herein, “microorganism” refers to a bacterium, a fungus, a virus, a protozoan, and other microbes or microscopic organisms.

As used herein, “derivative” means a protein which is derived from a precursor protein (e.g., the native protein) by addition of one or more amino acids to either or both the C- and N-terminal end, substitution of one or more amino acids at one or a number of different sites in the amino acid sequence, deletion of one or more amino adds at either or both ends of the protein or at one or more sites in the amino acid sequence, or insertion of one or more amino acids at one or more sites in the amino acid sequence. The enzymes may be derivatives of known enzymes as long as they function as the non-derivatized enzyme to the extent necessary to by useful in the present processes, methods and compositions.

As used herein, a substance (e.g., a polynucleotide or protein) “derived from” a microorganism means that the substance is native to the microorganism.

### Desizing Enzymes

Any suitable desizing enzyme may be used in the present invention. Preferably, the desizing enzyme is an amylolytic enzyme. Mannanases and glucoamylases also find use herein. More preferably, the desizing enzyme is an α- or β-amylase and combinations thereof.

Amylases

Alpha and beta amylases which are appropriate in the context of the present invention include those of bacterial or fungal origin. Chemically or genetically modified mutants of such amylases are also included in this connection. Preferred α-amylases include, for example, α-amylases obtainable from Bacillus species. Useful amylases include but are not limited to Optisize 40, Optisize 160, Optisize HT 260, Optisize HT 520, Optisize HT Plus, Optisize FLEX (all from Genencor Int. Inc.), Duramyl™, Termamyl™, Fungamyl™ and BAN™ (all available from Novozymes A/S, Bagsvaerd, Denmark). Other preferred amylolytic enzymes are CGTases (cyclodextrin glucanotransferases, EC 2.4.1.19), e.g., those obtained from species of Bacillus, Thermoanaerobactor or Thermoanaero-bacterium.

The activity of Optisize 40 and Optisize 160 is expressed in RAU/g of product. One RAU is the amount of enzyme which will convert 1 gram of starch into soluble sugars in one hour under standard conditions. The activity of Optisize HT 260, Optisize HT 520 and Optisize HT Plus is expressed in TTAU/g. One TTAU is the amount of enzyme that is needed to hydrolyze 100 mg of starch into soluble sugars per hour under standard conditions. The activity of Optisize FLEX is determined in TSAU/g. One TSAU is the amount of enzyme needed to convert 1 mg of starch into soluble sugars in one minute under standard conditions.

Dosage of the amylase varies depending on the process type. Smaller dosages would require more time than larger dosages of the same enzyme. However, there isn't an upper limit on the amount of desizing amylase other than what may be dictated by the physical characteristics of the solution. Excess enzyme does not hurt the fabric; it allows for a shorter processing time. Based on the foregoing and the enzyme utilized the following minimum dosages for desizing are suggested:

| | Minimum dosage (per | Typical Range (per |
|---|---|---|
| Amylase Product | liter of desizing liquor) | liter of desizing liquor) |
| Optisize 40 | 1,000 RAU | 2,000-70,000 RAU |
| Optisize 160 | 1,000 RAU | 2,000-70,000 RAU |
| Optisize HT 260 | 1,000 TTAU | 3,000-100,000 TTAU |
| Optisize HT 520 | 1,000 TTAU | 3,000-100,000 TTAU |
| Optisize HT Plus | 1,000 TTAU | 3,000-100,000 TTAU |
| Optisize FLEX | 5,000 TSAU | 13,000-65,000 TSAU |

The desizing enzymes may also preferably be derived from the enzymes listed above in which one or more amino acids have been added, deleted, or substituted, including hybrid polypeptides, so long as the resulting polypeptides exhibit desizing activity. Such variants useful in practicing the present invention can be created using conventional mutagenesis procedures and identified using, e.g., high-throughput screening techniques such as the agar plate screening procedure.

The desizing enzyme is added to the aqueous solution (i.e., the treating composition) in an amount effective to desize the textile materials. Typically, desizing enzymes, such as α-amylases, are incorporated into the treating composition in amount from 0.0001% to 2% of enzyme protein by weight of the fabric, preferably in an amount from 0.0001% to 1% of enzyme protein by weight of the fabric, more preferably in an amount from 0.001% to 0.5% of enzyme protein by weight of the fabric, and even more preferably in an amount from 0.01% to about 0.2% of enzyme protein by weight of the fabric.

### Bioscouring Enzymes

Pectinases

Any pectinolytic enzyme composition with the ability to degrade the pectin composition of, e.g., plant cell walls may be used in practicing the present invention. Suitable pectinases include, without limitation, those of fungal or bacterial origin. Chemically or genetically modified pectinases are also encompassed. Preferably, the pectinases used in the invention are recombinantly produced or of natural origin. They may be mono-component enzymes.

Pectinases can be classified according to their preferential substrate, highly methyl-esterified pectin or low methyl-esterified pectin and polygalacturonic acid (pectate), and their reaction mechanism, β-elimination or hydrolysis. Pectinases can be mainly endo-acting, cutting the polymer at random sites within the chain to give a mixture of oligomers, or they may be exo-acting, attacking from one end of the polymer and producing monomers or dimers. Several pectinase activities acting on the smooth regions of pectin are included in the classification of enzymes provided by Enzyme Nomenclature (1992), e.g., pectate lyase (EC 4.2.2.2), pectin lyase (EC 4.2.2.10), polygalacturonase (EC 3.2.1.15), exo-polygalacturonase (EC 3.2.1.67), exo-polygalacturonate-lyase (EC 4.2.2.9) and exo-poly-alpha-galacturonosidase (EC 3.2.1.82). In preferred embodiments, the methods of the Invention utilize pectate lyases.

Pectate lyase enzymatic activity as used herein refers to catalysis of the random cleavage of α-1,4-glycosidic linkages in pectic acid (also called polygalcturonic acid) by transelimination. Pectate lyases are also termed polygalacturonate lyases and poly(1,4-D-galacturonide) lyases. For purposes of the present invention, pectate lyase enzymatic activity is the activity determined by measuring the increase in absorbance at 235 nm of a 0.1% w/v solution of sodium polygalacturonate in 0.1 M glycine buffer at pH 10 (See Collmer et al., 1988, (1988). Assay methods for pectic enzymes. Methods Enzymol 161, 329-335). Enzyme activity is typically expressed as x mol/m in, i.e., the amount of enzyme that catalyzes the formation of x mole product/min. An alternative assay measures the decrease in viscosity of a 5% w/v solution of sodium polygalacturonate in 0.11 M glycine buffer at pH 10, as measured by vibration viscometry (APSU units). It will be understood that any pectate lyase may be used in practicing the present invention.

Non-limiting examples of pectate lyases whose use is encompassed by the present invention include pectate lyases that have been cloned from different bacterial genera such as Erwinia, Pseudomonas, Bacillus, Klebsiella and Xanthomonas. Pectate lyases suitable for use herein are from Bacillus subtilis (Nasser, et al. (1993) FEBS Letts. 335:319-326) and Bacillus sp. YA-14 (Kim, et al. (1994) Biosci. Biotech. Biochem. 58:947-949). Other pectate lyases produced by Bacillus pumilus (Dave and Vaughn (1971) J. Bacteriol. 108:166-174). B. polymyxa (Nagel and Vaughn (1961) Arch. Biochem. Biophys. 93:344-352). B. stearothermophilus (Karbassi and Vaughn (1980) Can. J. Microbiol. 26:377-384), Bacillus sp. (Hasegawa and Nagel (1966) J. Food Sci. 31:838-845) and Bacillus sp. RK9 (Kelly and Fogarty (1978) Can. J. Microbiol. 24:1164-1172) have also been described and are contemplated to be used in the present compositions and methods. Any of the above, as well as diva lent cation-independent and/or thermostable pectate lyases, may be used in practicing the invention.

In preferred embodiments, the pectate lyase comprises, for example, those disclosed in WO 04/090099 (Diversa) and WO 03/095638 (Novo).

An effective amount of pectolytic enzyme to be used according to the method of the present invention depends on many factors, but according to the invention the concentration of the pectolytic enzyme in the aqueous medium may be from about 0.0001% to about 1% microgram enzyme protein by weight of the fabric, preferably 0.0005% to 0.2% enzyme protein by weight of the fabric, more preferably 0.001% to about 0.05% enzyme protein by weight of the fabric.

Cutinases

Any cutinase suitable for use in the present invention may be used, including, for example, the cutinase derived from Humicola insolens cutinase strain DSM 1800, as described in Example 2 of U.S. Pat. No. 4,810,414 (incorporated herein by reference) or, in a preferred embodiment, the microbial cutinase from Pseudomonas mendocina described in U.S. Pat. No. 5,512,203, variants thereof and/or equivalents. Suitable variants are described, for example, in WO 03/76580.

Suitable bacterial cutinases may be derived from a Pseudomonas or Acinetobacter species, preferably from P. stutzeri, P. alcaligenes, P. pseudoalcaligenes, P. aeruginosa or A. calcoaceticus, most preferably from P. stutzeri strain That IV 17-1 (CBS 461.85), PG-1-3 (CBS 137.89), PG-1-4 (CBS 138.89), PG-II-11.1 (CBS 139.89) or PG-II-11.2 (CBS 140.89), P. aeruginosa PAO (ATCC 15692), P. alcaligenes DSM 50342, P. pseudoalcaligenes IN II-5 (CBS 468.85), P. pseudoalcaligenes M-1 (CBS 473.85) or A. calcoaceticus Gr V-39 (CBS 460.85). With respect to the use of cutinases derived from plants, it is known that cutinases exist in the pollen of many plants and such cutinases would be useful in the present processes, methods and compositions. Cutinases may also be derived a fungus, such as, Absidia spp.; Acremonium spp.; Agaricus spp.; Anaeromyces spp.; Aspergillus spp., including A. auculeatus, A. awamon, A. flavus, A. foetidus, A. fumaricus, A. fumigatus, A. nidulans, A. niger, A. oryzae, A. terreus and A. versicolor, Aeurobasidium spp.; Cephalosporum spp.; Chaetomium spp.; Coprinus spp.; Dactyllum spp.; Fusarium spp., including F. conglomerans, F. decemcellulare, F. javanicum, F. lini, F. oxysporum and F. solani; Gliocladium spp.; Humicola spp., including H. insolens and H. lanuginosa; Mucor spp.; Neurospora spp., including N. crassa and N. sitophila; Neocallimastix spp.; Orpinomyces spp.; Penicillium spp; Phanerochaete spp.; Phlebia spp.; Piromyces spp.; Pseudomonas spp.; Rhizopus spp.; Schizophylium spp.; Trametes spp.; Trichodenma spp., including T reesei, T. reesei (longibrachiatum) and T. viride; and Zygorhynchus spp. Similarly, it is envisioned that a cutinase may be found in bacteria such as Bacillus spp.; Cellulomonas spp.; Clostridium spp.; Myceliophthora spp.; Pseudomonas spp., including P. mendocina and P. putida; Thermomonospora spp.; Thermomyces spp., including T. lanuginose; Streptomyces spp., including S. olivochromogenes; and in fiber degrading ruminal bacteria such as Fibrobacter succinogenes; and in yeast including Candida spp., including C. Antarctica, C. rugosa, torresii; C. parapsilosis; C. sake; C. zeylanoides; Pichia minuta; Rhodotorula glutinis; R. mucilaginosa; and Sporobolomyces holsaticus.

Cutinases are preferably incorporated in the aqueous enzyme solution in an amount from 0.00001% to 2% of enzyme protein by weight of the fabric, preferably in an amount from 0.0001% to 1% of enzyme protein by weight of the fabric, more preferably in an amount from 0.005% to 0.5% of enzyme protein by weight of the fabric, and even more preferably in an amount from 0.001% to 0.5% of enzyme protein by weight of the fabric.

Cellulases

Cellulases are also contemplated for use in the methods and compositions described herein for bioscouring. Cellulases are classified in a series of enzyme families encompassing endo- and exo-activities as well as cellobiose hydrolyzing capability. The cellulase used in practicing the present invention may be derived from microorganisms which are known to be capable of producing cellulolytic enzymes, such as, e.g., species of Humicola, Thermomyces, Bacillus, Trichoderma, Fusarium, Myceliophthora, Phanerochaete, Irpex, Scytalidiu, Schizophyllum, Penicillium, Aspergillus or Geotricum. Known species capable for producing celluloytic enzymes include Humicola insolens, Fusarium oxysporum or Trichoderma reesei. Non-limiting examples of suitable cellulases are disclosed in U.S. Pat. No. 4,435,307; European patent application No. 0 495 257; PCT Patent Application No. WO91/17244; and European Patent Application No. EP-A2-271 004, all of which are incorporated herein by reference.

Cellulases are also useful for biopolishing of the textile. Cotton and other natural fibers based on cellulose can be improved by an enzymatic treatment known as “biopolishing.” This treatment gives the fabric a smoother and glossier appearance. The treatment is used to remove “fuzz”—the tiny strands of fiber that protrude from the surface of yarn. A ball of fuzz is called a “pill” in the textile trade. After biopolishing, the fuzz and pilling are reduced. The other benefits of removing fuzz are a softer and smoother handle and superior color brightness.

In an embodiment of the process of the invention the cellulase may be used in a concentration in the range from 0.0001% to 1% enzyme protein by weight of the fabric, preferably 0.0001% to 0.05% enzyme protein by weight of the fabric, especially 0.0001 to about 0.01% enzyme protein by weight of the fabric.

Determination of cellulase activity (ECU) The cellulolytic activity may be determined in endo-cellulase units (ECU) by measuring the ability of the enzyme to reduce the viscosity of a solution of carboxymethyl cellulose (CMC). The ECU assay quantifies the amount of catalytic activity present in the sample by measuring the ability of the sample to reduce the viscosity of a solution of carboxy-methylcellulose (CMC). The assay is carried out in a vibration viscosimeter (e.g. MIVI 3000 from Sofraser, France) at 40° C.; pH 7.5; 0.1 M phosphate buffer; time 30 minutes using a relative enzyme standard for reducing the viscosity of the CHIC substrate (Hercules 7 LED), enzyme concentration approx. 0.15 ECU/ml. The arch standard is defined to 8200 ECU/g.

One ECU is amount of enzyme that reduces the viscosity to one half under these conditions.

Other Bioscouring Enzymes

The present invention is not limited to the use of the enzymes discussed above for bioscouring. Other enzymes may be used either alone or in combination with each other or with those listed above. For example, proteases may be used in the present invention. Suitable proteases include those of animal, vegetable or microbial origin, preferably of microbial origin. The protease may be a serine protease or a metalloprotease, preferably an alkaline microbial protease or a trypsin-like protease. Examples of proteases include aminopeptidases, including prolyl aminopeptidase (3.4.11.5), X-pro aminopeptidase (3.4.11.9), bacterial leucyl aminopeptidase (3.4.11.10), thermophilic aminopeptidase (3.4.11.12), lysyl aminopeptidase (3.4.11.15), tryptophanyl aminopeptidase (3.4.11.17), and methionyl aminopeptidase (3.4.11.18); serine endopeptidases, including chymotrypsin (3.4.21.1), trypsin (3.4.21.4), cucumisin (3.4.21.25), brachyurin (3.4.21.32), cerevisin (3.4.21.48) and subtilisin (3.4.21.62); cysteine endopeptidases, including papain (3.4.22.2), ficain (3.4.22.3), chymopapain (3.4.22.6), asclepain (3.4.22.7), actimidain (3.4.22.14), caricain (3.4.22.30) and ananain (3.4.22.31); aspartic endopeptidases, including pepsin A (3.4.23.1), Aspergillopepsin I (3.4.23.18), Penicillopepsin (3.4.23.20) and Saccharopepsin (3.4.23.25); and metalloendopeptidases, including Bacillolysin (3.4.24.28).

Non-limiting examples of subtilisins include subtilisin BPN′, subtilisin amylosacchariticus, subtilisin 168, subtilisin mesentericopeptidase, subtilisin Carlsberg, subtilisin DY, subtilisin 309, subtilisin 147, thermitase, aqualysin, Bacillus PB92 protease, proteinase K, protease TW7, and protease TW3.

Commercially available proteases include Alcalase™, Savinase™, Primase™, Duralase™, Esperase™, Kannase™, and Durazym™ (Novo Nordisk A/S), Maxatase™, Maxacal™, Maxapem™, Properase™, Purafect™, Purafect OxP™, FN2™ and FN3™ (Genencor International Inc.).

Also useful in the present invention are protease variants, such as those disclosed in patents or published patent applications EP 130,756 (Genentech), EP 214,435 (Henkel), WO 87/04461 (Amgen), WO 87/05050 (Genex), EP 251,446 (Genencor), EP 260,105 (Genencor), Thomas, et al., (1985), Nature. 318, p. 375-376, Thomas, et al., (1987), J. Mol. Biol., 193, pp. 803-813. Russel, et al., (1987), Nature, 328, p. 496-500, WO 88/08028 (Genex), WO 88/08033 (Amgen), WO 89/06279 (Novo Nordisk A/S), WO 91/00345 (Novo Nordisk A/S), EP 525 610 (Solvay) and WO 94/02618 (Gist-Brocades N.V.), all of which are incorporated herein by reference.

The activity of proteases can be determined as described in “Methods of Enzymatic Analysis,” third edition, 1984, Verlag Chemie, Weinheim, vol 5.

In other embodiments of the present invention, it is contemplated that lipases are used for the bioscouring of textiles either alone or with other bioscouring enzymes of the present invention. Suitable lipases (also, termed carboxylic ester hydrolases) include, without limitation, those of bacterial or fungal origin, including triacylglycerol lipases (3.1.1.3) and Phospholipase A₂ (3.1.1.4.). Lipases for use in the present invention include, without limitation, lipases from Humicola (synonym Thermomyces), such as from H. lanuginosa (T. lanuginosus) as described in patents or published patent applications EP 258,068 and EP 305,216 or from H. insolens as described in WO 96/13580; a Pseudomonas lipase, such as from P. alcaligenes or P. pseudoalcaligenes (EP 218,272), P. cepacia (EP 331,376), P. stutzen (GB 1,372,034). P. fluorescens, Pseudomonas sp. strain SD 705 (WO 95/06720 and WO 96/27002), P. wisconsinensis (WO 96/12012); a Bacillus lipase, such as from B. subtilis (Dartois, et al., Biochem. Biophys. Acta, 1131:253-360, 1993); B. stearothermophilus (JP 64/744992) or B. pumilus (WO 91/16422), all references are herein incorporated by reference. Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202, all of which are incorporated herein by reference. Preferred commercially available lipase enzymes include Lipolase™ and Lipolase Ultra™, Lipozyme™, Palatase™, Novozym™ 435 and Lecitase™ (all available from Novo Nordisk A/S). The activity of the lipase can be determined as described in “Methods of Enzymatic Analysis”, Third Edition, 1984, Verlag Chemie, Weinhein, vol. 4.

It will be understood that any enzyme exhibiting bioscouring activity may be used in practicing the invention. That is, bioscouring enzymes derived from other organisms, or bioscouring enzymes derived from the enzymes listed above in which one or more amino acids have been added, deleted, or substituted, including hybrid polypeptides, may be used, so long as the resulting polypeptides exhibit bioscouring activity. Such variants useful in practicing the present invention can be created using conventional mutagenesis procedures and identified using, e.g., high-throughput screening techniques such as the agar plate screening procedure. For example, pectate lyase activity may be measured by applying a test solution to 4 mm holes punched out in agar plates (such as, for example, LB agar), containing 0.7% w/v sodium polygalacturonate (Sigma P 1879). The plates are then incubated for 6 h at a particular temperature (such as, e.g., 75° C.). The plates are then soaked in either (i) 1 M CaCl₂ for 0.5 h or (ii) 1% mixed alkyl trimethylammonium Br (MTAB, Sigma M-7635) for 1 h. Both of these procedures cause the precipitation of polygalacturonate within the agar. Pectate lyase activity can be detected by the appearance of clear zones within a background of precipitated polygalacturonate. Sensitivity of the assay is calibrated using dilutions of a standard preparation of pectate lyase.

### Bleaching Agents

In one embodiment of the present invention, bleaching agents are used to treat the textiles of the present invention. The present invention is not limited to the use of a bleaching agent or to the use of any particular bleaching agent. Likewise, the present invention is not limited to the use of only one bleaching agent. Exemplary bleaching agents of the present invention are, for example, hydrogen peroxide, carbamide peroxide, sodium carbonate peroxide, sodium peroxide, sodium perborate, sodium hypochlorite, calcium hypochlorite and sodium dichloroisocyanurate. In a preferred embodiment, hydrogen peroxide is used as a bleaching agent. In another embodiment, enzymatic biobleaching agents are used alone or with non-enzymatic bleaching agents. Non-limiting examples of enzymatic biobleaching agents are peroxidases (Colonna, et al., Recent biological developments in the use of peroxidases, Tibtech, 17:163-168, 1999) and oxidoreductases (e.g., glucose oxidases) (Pramod, Liquid laundry detergents containing stabilized glucose-glucose oxidative system for hydrogen peroxide generation, U.S. Pat. No. 5,288,746).

The use of the perhydrolases of the present compositions and methods in combination with additional chemical bleaching agent(s) such as sodium percarbonate, sodium perborate, sodium sulfate/hydrogen peroxide adduct and sodium chloride/hydrogen peroxide adduct and/or a photo-sensitive bleaching dye such as zinc or aluminum salt of sulfonated phthalocyanine further improves the bleaching effects. In additional embodiments, the perhydrolases of the present invention are used in combination with bleach boosters (e.g., TAED, NOBS).

### Enzymatic Bleaching Systems

Key components to peracid production by enzymatic perhydrolysis are enzyme, ester substrate, and hydrogen peroxide.

### Hydrogen Peroxide

Hydrogen peroxide can be either added directly in batch, or generated continuously “in situ.” The acyl transferase enzymes also find use with any other suitable source of H₂O₂, including that generated by chemical, electrochemical, and/or enzymatic means. Examples of chemical sources are the percarbonates and perborates, while an example of an electrochemical source is a fuel cell fed oxygen and hydrogen gas, and an enzymatic example includes production of H₂O₂ from the reaction of glucose with glucose oxidase. The following equation provides an example of a coupled system that finds use with the present invention.

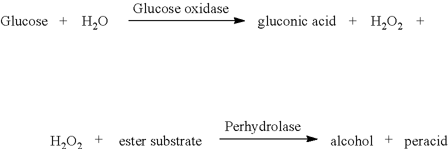

It is not intended that the present invention be limited to any specific enzyme, as any enzyme that generates H₂O₂ with a suitable substrate finds use in the methods of the present invention. For example, lactate oxidases from Lactobacillus species which are known to create H₂O₂ from lactic acid and oxygen find use with the present invention. Indeed, one advantage of the methods of the present invention is that the generation of acid (e.g., gluconic acid in the above example) reduces the pH of a basic solution to the pH range in which the peracid is most effective in bleaching (i.e., at or below the pKa). Other enzymes (e.g., alcohol oxidase, ethylene glycol oxidase, glycerol oxidase, amino acid oxidase, etc.) that can generate hydrogen peroxide also find use with ester substrates in combination with the perhydrolase enzymes of the present invention to generate peracids. In some preferred embodiments, the ester substrates are selected from one or more of the following acids: formic acid, acetic acid, propionic acid, butyric acid, valeric acid, caproic acid, caprylic acid, nonanoic acid, decanoic acid, dodecanoic acid, myrislic acid, palmitic acid, stearic acid, and oleic acid. Thus, as described herein, the present invention provides definite advantages over the currently used methods and compositions for textile bleaching.

Acyl Transferase

Acyl transferases that find use in the present are described in WO 05/056782.

The use of enzymes obtained from microorganisms is long-standing. Indeed there are numerous biocatalysts known in the art. For example, U.S. Pat. No. 5,240,835 (herein incorporated by reference) provides a description of the transacylase activity of obtained from C. oxydans and its production. In addition, U.S. Pat. No. 3,823,070 (herein incorporated by reference) provides a description of a Corynebacterium that produces certain fatty acids from an n-paraffin. U.S. Pat. No. 4,594,324 (herein incorporated by reference) provides a description of a Methylcoccus capsulatus that oxidizes alkenes. Additional biocatalysts are known in the art (See e.g., U.S. Pat. Nos. 4,008,125 and 4,415,657; both of which are herein incorporated by reference). EP 0 280 232 describes the use of a C. oxydans enzyme in a reaction between a diol and an ester of acetic acid to produce monoacetate. Additional references describe the use of a C. oxydans enzyme to make chiral hydroxycarboxylic acid from a prochiral diol. Additional details regarding the activity of the C. oxydans transacylase as well as the culture of C. oxydans, preparation and purification of the enzyme are provided by U.S. Pat. No. 5,240,835 (incorporated by reference, as indicated above). Thus, the transesterification capabilities of this enzyme, using mostly acetic acid esters were known. However, the determination that this enzyme could carry out perhydrolysis reaction was quite unexpected. It was even more surprising that these enzymes exhibit very high efficiencies in perhydrolysis reactions. For example, in the presence of tributyrin and water, the enzyme acts to produce butyric acid, while in the presence of tributyrin, water and hydrogen peroxide, the enzyme acts to produce mostly peracetic acid and very little butyric acid. This high perhydrolysis to hydrolysis ratio is a unique property exhibited by the perhydrolase class of enzymes of the present invention and is a unique characteristic that is not exhibited by previously described lipases, cutinases, nor esterases.

The perhydrolase of the present invention is active over a wide pH and temperature range and accepts a wide range of substrates for acyl transfer. Acceptors include water (hydrolysis), hydrogen peroxide (perhydrolysis) and alcohols (classical acyl transfer). For perhydrolysis measurements, enzyme is incubated in a buffer of choice at a specified temperature with a substrate ester in the presence of hydrogen peroxide. Typical substrates used to measure perhydrolysis include esters such as ethyl acetate, triacetin, tributyrin and others. In addition, the wild type enzyme hydrolyzes nitrophenylesters of short chain acids. The latter are convenient substrates to measure enzyme concentration. Peracid and acetic acid can be measured by the assays described herein. Nitrophenylester hydrolysis is also described.

Although the primary example used during the development of the present invention is the M. smegmatis perhydrolase, any perhydrolase obtained from any source which converts the ester into mostly peracids in the presence of hydrogen peroxide finds use in the present invention.

In an embodiment of the process the perhydrolyase may be used in a concentration in wash liquor in the range from 0.0001-100 ppm; preferably 0.0001-50 ppm; more preferably 0.0001-25 ppm; preferably 0.0001-10 ppm. In another embodiment of the process the perhydrolyase may be used in a concentration of: 0.0001-1% per gram of fabric; more preferably 0.0001-0.1% per gram of fabric, or 0.0001-0.01% per gram of fabric.

### Substrates

In some preferred embodiments of the present invention, esters comprising aliphatic and/or aromatic carboxylic acids and alcohols are utilized with the perhydrolase enzymes in the present compositions. In some preferred embodiments, the ester substrates are selected from one or more of the following: formic acid, acetic acid, propionic acid, butyric acid, valeric acid, caproic acid, caprylic acid, nonanoic acid, decanoic acid, dodecanoic acid, myristic acid, palmitic acid, stearic acid, and oleic acid. Thus, in some preferred embodiments, compositions comprising at least one perhydrolase, at least one hydrogen peroxide source, and at least one ester acid are provided. In additional embodiments, triacetin, tributyrin, and other esters serve as acyl donors for peracid formation.

### Process Conditions

The manner in which the aqueous solution containing the enzyme(s) and bleaching system is contacted with the textile material will depend upon whether the processing regime is continuous, semi-continuous, discontinuous pad-batch, batch (or continuous flow). For example, for continuous or discontinuous pad-batch processing, the aqueous enzyme solution is preferably contained in a saturator bath and is applied continuously to the textile material as it travels through the bath, during which process the textile material typically absorbs the processing liquor at an amount of, for example, 0.5-1.5 times its weight. In batch operations, the fabric is exposed to the enzyme solution for a period ranging from about 2 minutes to 24 hours at a liquor-to-fabric ratio of 5:1-50:1. These are general parameters. In some embodiments, the time may be shortened by used of more concentrated solutions of the enzymes and other compounds of the present invention. One skilled in the art is able to determine the parameters best suited for their individual needs.

The methods disclosed herein may be performed at lower temperatures than traditional scouring, desizing and bleaching techniques. In one embodiment, the methods are conducted at temperatures below 95° C., preferably between about 15° C. and 95° C. In a more preferred embodiment, the methods of the present invention are performed at between about 24° C. and 80° C. In the preferred embodiment, the methods of the present invention are performed at about 40° C. to about 60° C. with satisfactory results.

The methods of the present invention may be performed at a pH range closer to neutral than traditional desizing, scouring or bleaching techniques. Although the present methods find use at a pH between about 5 and 11, a pH lower than 9 is preferred. In one embodiment, the pH at which the methods of the present invention is performed in between about 6 and 9, and preferably between 6 and 8. In a more preferred embodiment, the pH at which the methods of the present invention are performed are between about 7.5 and 8.5. In a yet more preferred embodiment, the pH is about 8.0.

One of ordinary skill in the art will recognize that the process conditions to be used in performing the present invention may be selected so as to match a particular equipment or a particular type of process which it is desirable to use. For example, while the textile in need of treatment preferably remains in contact with the treatment solution at a temperature of from about 15° C. to about 90° C., preferably from about 24° C. to about 80° C., most preferably about 40° C. to about 60° C. and for a period of time suitable for treating the textile which is at least about 2 minutes to 24 hours, more preferably from about 30 minutes to about 12 hours, preferably from about 30 minutes to about 6 hours and most preferably from about 30 to about 90 minutes. Of course, one of ordinary skill in the art will recognize that the reaction conditions such as time and temperature will vary depending upon the equipment and/or process employed and the fabrics treated.

Preferred examples of process types to be used in connection with the present invention include but not limited to Jet, Jigger/Winch, Pad-Roll and Pad-Steam types, and continuous bleaching range. The combined process of the invention may be carried out as a batch, semi-continuous or continuous process using steam or the principles of cold-bleaching. As an example the process may comprise the following steps: a) impregnating the fabric in a scouring and bleaching bath as described herein followed by squeezing out excessive liquid so as to maintain the quantity of liquor necessary for the reaction to be carried out (normally between 60% and 120% of the weight of the dry fabric), (b) subjecting the impregnated fabric to steaming so as to bring the fabric to the desired reaction temperature, generally between about 20° C. and about 80° C., and (c) holding by rolling up or pleating the cloth in a J-Box, U-Box, carpet machine or the like for a sufficient period of time to allow the scouring and bleaching to occur.

As mentioned elsewhere, desizing may be a desired result. Therefore, for certain types of fabric it may be advantageous and/or necessary to subject the fabric to a desizing treatment in order to obtain a final product of a desired quality. In such cases, the present invention may be employed as a combined de-sizing, bleaching and scouring process, or combined desizing and bleaching process, or a combined desizing and scouring process.

The method of the present invention involves providing a non-finished textile component into the treatment solution as described. The textile component may comprise fibers, yarns, fabrics including wovens, knits, garments and non-wovens. By non-finished, it is intended that the textile component be a material that has not been desized, scoured, bleached, dyed, printed, or otherwise provided a finishing step such as durable press. Of course, one of ordinary skill in the art will recognize that the textile of the present invention are those that have not been passed through a garment or other manufacturing process involving cutting and sewing of the material.

The present process may be employed with any textile material including cellulosics such as cotton, linen, ramie, hemp, rayon, lyocell, cellulose acetate and cellulose triacetate, and synthetic material including but not limited to polyester, nylon, spandex, lycra, acrylics, and various other natural and synthetic material blends. For the purposes of the present invention, natural material may include protein fibers such as wool, silk, cashmere, as well as cellulosics as described herein.

The present process may be employed for bleaching without appreciable fiber or fabric damage to several types of synthetic textiles and their blends, including but not limited to polyester, rayon, acetate, nylon, cotton/polyester, cotton/lycra, etc., which may susceptible to alkaline hydrolysis and degradation.

The method of the present invention may include the further steps of singeing, and mercerization after the treatment step. While desizing may be employed in a separate step, in preferred embodiments the desizing step is including in the one step treatment of the present invention via the inclusion of a desizing enzyme(s) in the treatment bath thereby combining, bleaching, de-sizing and scouring into a single step.

Of course the process of the present invention includes in the preferred application a washing step or series of washing steps following the one-step treatment methods provided for herein. Washing of treated textiles is well known and within the level of skill of the artisan. Washing stages will be typically present after each of the desizing, scouring and bleaching steps when present as well as after the treatment step of the present invention. In addition, the treatment steps, irrespective of their order and/or combinations, may in preferred embodiments include a wet-out or prewetting step to ensure even or uniform wetting in the textile.

The method of the present invention provides superior wettability to textile components treated via the method. Wettability of the textiles is important to any dyeing and finishing of the textiles. Wettability leads to superior penetration of the textile by the dye or finish agents and a superior dye and/or finishing result. Accordingly, the wettability of the textile is an indication of how effective the treatment process has been. Higher wettability means a more effective and superior treatment process, i.e., a shorter period of time for wetting. Conventional textile peroxygen bleaching has provided acceptable wetting profiles only at temperature in excess of 95° C. while lower temperature bleaching (70° C.) results in wettability profiles more than about 40%. However, the process of the present invention provides fabrics that have an increase in the wettability index of less than about 10% preferably less than about 5% where the wettability Index is defined as:

[(wettability at 70° C.)−(wettability at 95° C.)]/(wettability at 95° C.)

in percent. An alternative test for absorbancy, e.g., AATCC Test Method 79-1995, can be used to quickly check wetting after the treatment.

For purposes of the present invention, fiber damage based on fluidity is measured via AATCC test method 82-1996 involving the dispersion of the fibers in cupriethylene diamine (CP). A representative sample of fibers of about 1.5 mm is cut and dissolved in CP as defined by the equation CP=120.times.sample weight.times.0.98 in a specimen bottle with several glass balls, placed under nitrogen and dissolved by shaking for approximately 2 hours. Additional CP is added as defined by the equation CP=80.times.sample weight.times.0.98 and additional shaking under nitrogen for three hours. The solution is placed under constant stirring to prevent separation of the dispersion. The solution is then measured in a calibrated Oswald Canon Fenske viscometer in a constant temperature bath of 25° C. to determine the efflux time. Fluidity is then calculated from the formula F=100/ctd, where c=viscometer constant, t=efflux time and d=density of the solution 1.052.

### Auxiliary Components

The treatment solutions of the present invention may also include various auxiliary components, also referred to herein as auxiliary chemicals. Such components include, but are not limited to, sequestering or chelating agents, wetting agents, emulsifying agents, pH control agents (e.g., buffers), bleach catalysts, stabilizing agents, dispersing agents, antifoaming agents, detergents and mixtures thereof. It is understood that such auxiliary components are in addition to the enzymes of the present invention, hydrogen peroxide and/or hydrogen peroxide source and material comprising an ester moiety. Wetting agents are typically selected from surfactants and in particular nonionic surfactants. When employed wetting agents are typically included at levels of from about 0.1 to about 20 g/L, more preferably from about 0.5 to about 10 g/L, and more preferably 0.5 to about 5 g/L of the bath. Stabilizing agents are employed for a variety of reasons including buffering capacity, sequestering, dispersing and in addition enhancing the performance of the surfactants. Stabilizing agents may slow the rate of peroxide decomposition and combine with or neutralize metal impurities which may catalyze decomposition of peroxide and induce fiber damage. Stabilizing agents are well known with both inorganic or organic species being well known and silicates and organophosphates gaining the broadest acceptance and when present are employed at levels of from about 0.01 to about 30 g/L, more preferably from about 0.01 to about 10 g/L and most preferably from about 0.01 to about 5 g/L of the bath.

### Surfactants

Surfactants suitable for use in practicing the present invention include, without limitation, nonionic (see, e.g., U.S. Pat. No. 4,565,647, which is herein incorporated by reference); anionic; cationic; and zwitterionic surfactants (see, e.g., U.S. Pat. No. 3,929,678, which is herein incorporated by reference); which are typically present at a concentration of between about 0.2% to about 15% by weight, preferably from about 1% to about 10% by weight. Anionic surfactants include, without limitation, linear alkylbenzenesulfonate, α-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid, and soap. Non-ionic surfactants include, without limitation, alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, and N-acyl N-alkyl derivatives of glucosamine (“glucamides”). A preferred surfactant for use in embodiments of the present invention is a non-ionic surfactant or a non-ionic and anionic blend.

### Chelating Agents

Chelating agents may also be employed and can be selected from the group consisting of amino carboxylates, amino phosphonates, polyfunctionally-substituted aromatic chelating agents and mixtures therein, all as hereinafter defined.

Amino carboxylates useful as optional chelating agents include ethylenediaminetetracetates, N-hydroxyethylethylenediaminetriacetates, nitrilotriacetates, ethylenedlamine tetraproprionates, triethylenetetraaminehexacetates, phosphonates to not contain alkyl or alkenyl groups with more than about 6 carbon atoms.

Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzenediethylenetriaminepentaacetates, and ethanoldiglycines, alkali metal, ammonium, and substituted ammonium salts therein and mixtures therein.

Amino phosphonates are also suitable for use as chelating agents in the compositions of the invention when at least low levels of total phosphorus are permitted.

A preferred biodegradable chelator for use herein is ethylenediamine disuccinate (“EDDS”), especially the [S,S] isomer as described in U.S. Pat. No. 4,704,233, Nov. 3, 1987, to Hartman and Perkins.

When present, chelating agents are employed at levels of from about 0.01 to about 10 g/L, more preferably from about 0.1 to about 5 g/L, and most preferably from about 0.2 to about 2 g/L.

### INDUSTRIAL APPLICATIONS OF THE INVENTION

The present invention has many practical applications in industry, as is contemplated herein, and this description is intended to be exemplary, and non-inclusive.

In one embodiment, the present invention has contemplated use in the textile industry, mainly in the processing of fibers, yarns, fabrics, garments, and non-wovens. Major applications include: the one-step enzymatic processing of textiles involving the scouring and bleaching of textiles. The desizing of the textiles, may also be accomplished simultaneously with, the scouring, bleaching, and the scouring and bleaching.

The given dosage (i.e., levels) of the enzyme components in the composition depends on the specific activity, the process conditions and the desired result. The dosage levels can be determined by one of skill in the art.

The compositions and methods described herein provide effective textile treatments with reduced strength loss compared to traditional chemical based treatments, e.g., alkali scouring, bleaching, etc. Without being bound by theory, it is believed that the compositions and methods damage the fibers less and thereby reducing strength loss when compared to conventional chemical treatments. Strength loss may be measured by techniques well known in the art such as ASTM D 5034 (Grab test), ASTM D 5035 (Strip test), ASTM D 3787 (Ball burst test), and/or ASTM D 3786 (Hydraulic bursting strength of knitted goods and nonwoven fabrics).

In the experimental disclosure which follows, the following abbreviations apply: eq (equivalents); M (Molar); μM (micromolar); N (Normal); mol (moles); mmol (millimoles); μmol (micromoles); nmol (nanomoles); g (grams); mg (milligrams): kg (kilograms); μg (micrograms); L (liters); ml (milliliters); μl (microliters); cm (centimeters); mm (millimeters); μm (micrometers); nm (nanometers); ° C. (degrees Centigrade); h (hours); min (minutes); sec (seconds); msec (milliseconds); Ci (Curies) mCi (milliCuries); μCi (microCuries); TLC (thin layer achromatography); Ts (tosyl); Bn (benzyl); Ph (phenyl); Ms (mesyl); Et (ethyl), Me (methyl).

### EXAMPLES

The present invention is described in further detain in the following examples which are not in any way intended to limit the scope of the invention as claimed. The attached Figures are meant to be considered as integral parts of the specification and description of the invention. All references cited are herein specifically incorporated by reference for all that is described therein. The following examples are offered to illustrate, but not to limit the claimed invention.

### Example 1

### One-Step Enzymatic Pre-Treatment of Cotton

This example illustrates one embodiment for the one-step enzymatic pretreatment (desizing, scouring and bleaching) of cotton and cotton-containing fibers and fabrics.

Tests were conducted on Army card cotton sateen greige fabric from Testfabrics (West Pittiston, Pa.), style #428R and army carded cotton sateen, desized but not bleached fabric from Testfabrics, style #428U.

The enzymes used were:
Acyl transferase variant S51A98T (Genencor; WO 05/056782) at 1 ppm
Purastar OxAm 4000E (Genencor oxidative stable α-amylase) at 1 g/L
Optisize 160 (Genencor conventional α-amylase) at 2 ml/L
Bioprep 3000 L (Novozymes pectate lyase) at 6 ml/L
Cutinase (Genencor; P. mendocina cutinase described in U.S. Pat. No. 5,512,203 or a variant described in WO 03/76580 having the following mutations: F180P/S205G) at 4 ppm

Other compounds used were:
Surfactant: Triton X-100 at 0.25 g/L
Propylene Glycol Diacetate at 3000 ppm
Hydrogen peroxide at 2000 ppm
0.01% Ruthenium Red dye in pH 6.8, 50 mM phosphate buffer solution
Iodine solution (Iodine solution was prepared by dissolving 10 g of potassium iodide in 100 mL of DI water followed by adding 0.65 g of iodine and stirring the solution until complete dissolution. Then bring up the solution to 800 mL with DI water and then to 1 L with ethanol.)

To check combined desizing, scouring and bleaching effects, the experiments shown in Table 1 were done using three 4 inches×3 inches Army Carded Cotton Sateen greige fabric swatches (Stype #428R) from Testfabrics. All the exhaust experiments (1-19) were done in a Launder-O-meter at 50° C. and pH 8 for 60 minutes. Pad batch experiments were done after soaking the fabric in the reaction solution for 5 minutes, passing through rollers and then incubating at room temperature (24° C.) for 24 hours. After the treatments, all of the fabric samples were thoroughly rinsed with incoming water and then air-dried before evaluation. Commercially bleached Army Carded Sateen from Testfabrics were used as positive controls for all of the treatments.

TABLE 1

| No. | Treatments |
|---|---|
| 1 | Buffer |
| 2 | Buffer + Surfactant |
| 3 | Buffer + Surfactant + PGDA |
| 4 | Buffer + Surfactant + PGDA + H₂O₂ |
| 5 | Buffer + Surfactant + OxAm |
| 6 | Buffer + Surfactant + BP 3000L |
| 7 | Buffer + Surfactant + Cutinase |
| 8 | Buffer + Surfactant + PGDA + H₂O₂ + BP 3000L |
| 9 | Buffer + Surfactant + PGDA + H₂O₂ + Cutinase |
| 10 | Buffer + Surfactant + PGDA + H₂O₂ + AcT |
| 11 | Buffer + Surfactant + PGDA + H₂O₂ + AcT + OxAm + |
| | BP 3000L + Cutinase |
| 12 | Buffer + PDGA + H₂O₂ + AcT |
| 13 | Buffer + PDGA + H₂O₂ + OxAm |
| 14 | Buffer + PDGA + H₂O₂ + BP 3000L |
| 15 | Buffer + PDGA + H₂O₂ + Cutinase |
| 16 | Buffer + PDGA + H₂O₂ + Act + OxAm + BP 3000L + Cutinase |
| 17 | Buffer + PDGA + H₂O₂ |
| 18 | Buffer + Surfactant + PGDA + H₂O₂ (Pad Batch) |
| 19 | Buffer + Surfactant + PGDA + H₂O₂ + AcT + OS 160 + |
| | BP 3000L (Pad Batch) |
| 428R | Greige Fabric |
| 428U | Desized by Testfabrics |
| 428 | Commercial Bleach by Testfabrics |

Bleaching effects were quantified by measuring CIE L values, which indicate whiteness, using a spectrophotometer by Minolta, model number CR-2000. Higher CIE L-indicates improved bleaching.

Desizing effects were measured with iodine tests to measure residual starch that remained in the fabric after each treatment. A five ⅜ inch fabric disk was cut from each swatch and placed in 2 ml of the iodine solution per disk for approximately one minute. The disks were then quickly rinsed with cold water and dabbed with filter paper. CIE L* values of the disks were immediately measured by Reflectometer. Higher CIE L* values indicate less starch remained in the fabric and indicated better desizing performance.

Scouring effects were quantified by the water drop test. Ruthenium Red staining and visual evaluation of motes. The water drop test was done by dropping 10 μl of water onto a treated fabric surface and then measuring the time of the water drop to be absorbed by the fabric. Also, all of the treated fabrics were stained with 0.01% Ruthenium Red dye solution for 5 minutes to quantify the amount of pectin left in the fabric after treatments. Then, the stained fabrics were thoroughly rinsed and air dried before measuring the CIE L* values. The lower CIE L* value indicates higher pectin binding with relates to lower scouring performance. Motes removal was quantified by panel score units (PSU) where 0 indicated no motes and 5 indicated a high amount of motes. The results are shown in Table 2.

TABLE 2

| | | | | | PSU |
|---|---|---|---|---|---|
| | | Sec | | | Scouring |
| | CIE L* | Water Drop | CIE L * | CIE L * | (Motes |
| | Bleaching | Desizing | Desizing | Scouring | removal) |
| 1 | 85.5 | 8 | 48.4 | 33.0 | 5 |
| 2 | 86.1 | 1 | 51.0 | 35.3 | 5 |
| 3 | 85.9 | 1 | 46.6 | 31.4 | 5 |
| 4 | 89.1 | 1 | 49.7 | 31.2 | 4 |
| 5 | 86.4 | 1 | 52.8 | 45.6 | 5 |
| 6 | 86.2 | 1 | 55.6 | 34.4 | 5 |
| 7 | 86.0 | 1 | 47.6 | 33.6 | 5 |
| 8 | 89.4 | 1 | 54.4 | 33.0 | 3 |
| 9 | 89.5 | 1 | 49.9 | 31.4 | 3 |
| 10 | 91.8 | 1 | 47.5 | 35.3 | 1 |
| 11 | 91.6 | 1 | 55.5 | 45.1 | 1 |
| 12 | 89.1 | 24 | 48.2 | 28.8 | 4 |
| 13 | 91.8 | 16 | 49.5 | 29.0 | 2 |
| 14 | 89.8 | 1 | 48.7 | 41.9 | 4 |
| 15 | 89.4 | 18 | 54.9 | 27.7 | 4 |
| 16 | 89.5 | 11 | 48.4 | 28.3 | 4 |
| 17 | 91.4 | 1 | 53.3 | 40.5 | 1 |
| 18 | 87.7 | 1 | 47.4 | 28.4 | 4 |
| 19 | 90.1 | 1 | 54.4 | 36.0 | 1 |
| 428R | 86.1 | 300+ | 51.0 | 30.4 | 5 |
| 428U | NA | NA | NA | 49.8 | NA |
| 428 | 94.3 | 1 | 62.4 | 77.6 | 0 |

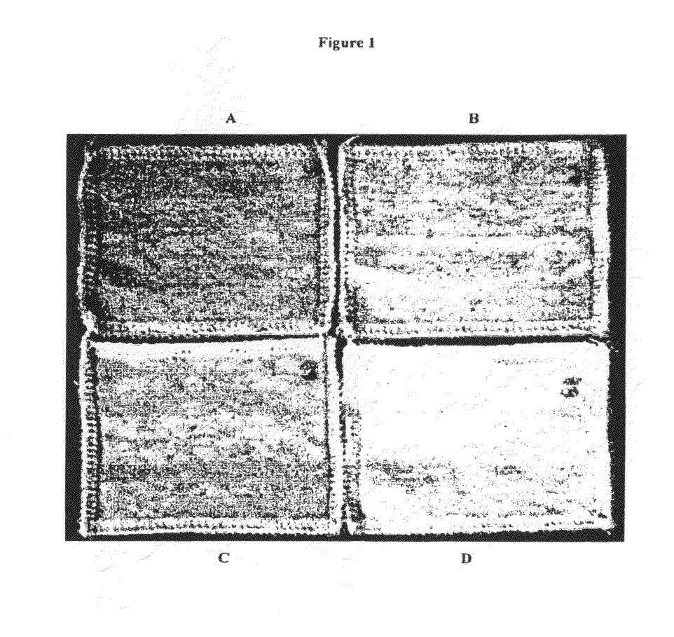

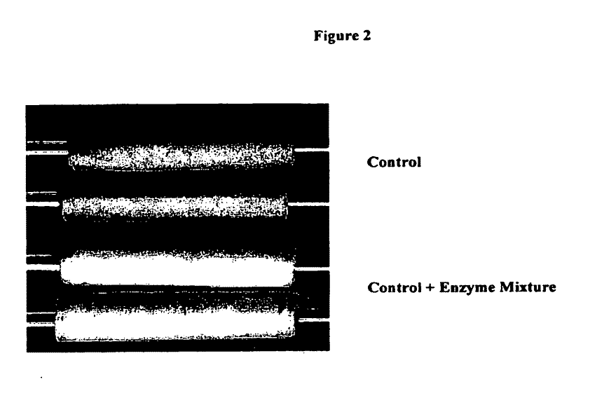

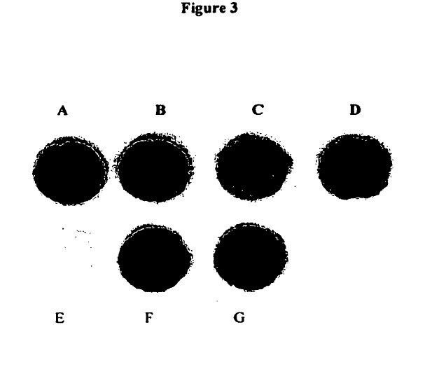

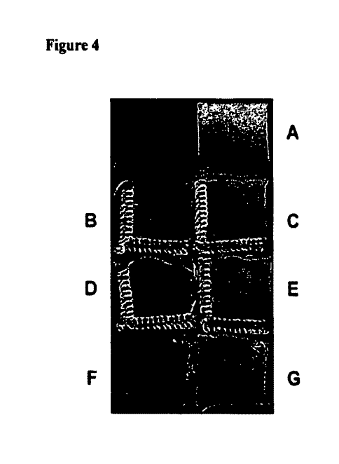

As shown in Table 2 and in FIGS. 1-4, the Army carded cotton sateen fabrics treated simultaneously with acyl transferase, α-amylase, pectate lyase in the presence of hydrogen peroxide and propylene glycol diacetate, exhibited significant amounts of desizing, scouring (with motes removal) and bleaching effects.

### Example 2

### Cotton Bleaching

In this Example, experiments to assess the use of the perhydrolase of the present invention for bleaching of cotton fabrics are described.

In these experiments, six cotton swatches per canister were treated at 55° C. for 60 minutes in a Launder-O-meter. The substrates used in these experiments were: 3 (3″×3″) 428U and 3 (3′×3″) 400U per experiments. Two different types of 100% unbleached cotton fabrics from Testfabrics were tested (style 428U (desized but not bleached army carded cotton sateen); and style 400U (desized but not bleached cotton print cloth). The liquor ratio was about 26 to 1 (˜7.7 g fabric/˜200 ml volume liquor). The perhydrolase enzyme was tested at 12.7 mgP/ml, with ethyl acetate (3% (v/v)), hydrogen peroxide (1500 ppm), and Triton X-100 (0.001%), in a sodium phosphate buffer (100 mM) for pH 7 and pH 8; as well as in a sodium carbonate (100 mM) buffer, for pH 9 and pH 10.

Bleaching effects were quantified with total color difference by taking 4 CIE L*a*b* values per each swatch before and after the treatments using a Chroma Meter CR-200 (Minolta), and total color difference of the swatches after the treatments were calculated according to the following:

Total color difference (ΔE)={square root over (ΔL²+Δa²+Δb²))}

(where ΔL, Δa, Δb, are differences in CIE L*, CIE a*, and CIE b* values respectively before and after the treatments).

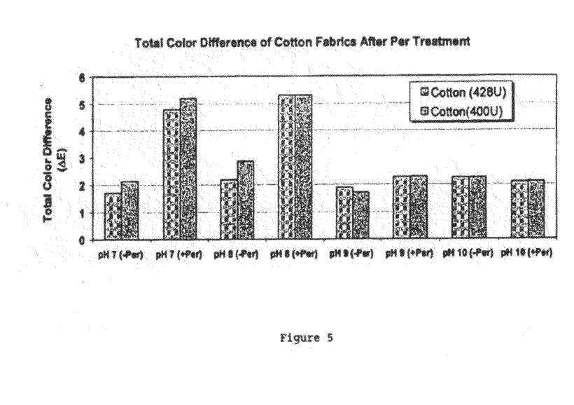

Higher ΔE values indicate greater bleaching effects. The results (See, FIG. 5) indicated that the perhydrolase showed significantly improved bleaching effects on both types of 100% cotton fabrics at pH 7 and pH 8 under the conditions tested.

It was also observed that high amounts of motes (e.g., pigmented spots) disappeared on the enzyme treated substrates.

### Example 3

### Linen Bleaching

In this Example, experiments conducted to assess the linen bleaching capability of the perhydrolase of the present invention are described. The same methods and conditions as describe above for cotton testing (in Example 2) were used to test linen swatches. As indicated above, experiments were conducted in a Launder-O-meter using a linen fabric (linen suiting, Style L-53; Testfabrics).

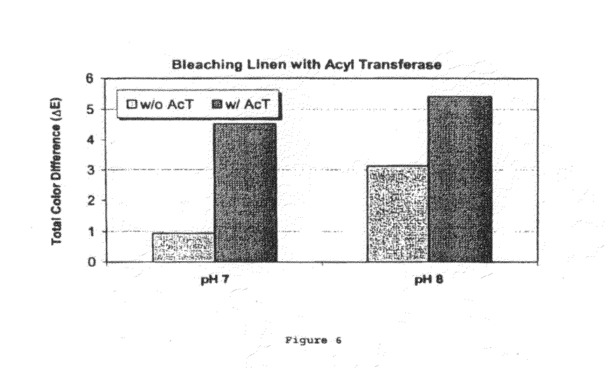

In these experiments, 3 (4″×4″) linen swatches were treated with 12.7 mgP/ml of the perhydrolase enzyme with ethyl acetate (3% v/v), hydrogen peroxide (1200 ppm), and Triton X-100 (0.001%), in a sodium phosphate buffer (100 mM) for pH 7 and pH 8. The bleaching effects were calculated as described above in Example 2. FIG. 6 provides a graph showing the bleaching effects of the perhydrolase of the present invention tested at pH 7 and pH 8 on linen.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. An enzymatic bleaching composition comprising: i) an ester source, ii) an acyl transferase, iii) hydrogen peroxide source.

2. The composition of claim 1 further comprising a bioscouring enzyme.

3. The composition of claim 1 further comprising a desizing enzyme.

4. The composition of claim 1, wherein said ester source is an acetate ester.

5. The composition of claim 1, wherein said ester source is selected from propylene glycol diacetate, ethylene glycol diacetate, triacetin, ethyl acetate and tributyrin.

6. The composition of claim 1, wherein said acyl transferase exhibits a perhydrolysis to hydrolysis ratio that is greater than 1.

7. The composition of claim 1, wherein the hydrogen peroxide source comprises a hydrogen peroxide generating oxidase and a suitable substrate.

8. The composition of claim 7, wherein the oxidase is a carbohydrate oxidase.

9. A one-step treatment composition comprising: i) one or more bioscouring enzymes, ii) one or more desizing enzymes, and iii) an enzymatic bleaching composition.

10. The composition of claim 9 further comprising one or more auxiliary components selected from surfactants, emulsifiers, chelating agents, dispersing agents and/or stabilizers.

11. The composition of claim 9 further comprising a bleach activator.

12. The composition of claim 9 further comprising a chemical bleaching agent.

13. The composition of claim 12 wherein the chemical bleaching agent is selected from oxidative bleaches, sodium peroxide, sodium hypochlorite, calcium hypochlorite and sodium dichloroisocyanurate or combinations thereof.

14. The composition of claim 9, wherein said bioscouring enzyme is selected from a group consisting of pectinases, cutinases, cellulases, hemicellulases, proteases and lipases.

15. The composition of claim 14, wherein said bioscouring enzyme is pectate lyase and/or combination of pectate lyase with other enzymes such as protease, cutinases, lipases and cellulases.

16. The composition of claim 9, wherein said desizing enzyme is selected from α-amylases and β-amylases.

17. The composition of claim 16, wherein said desizing enzyme is an α-amylase.

18. The composition of claim 10, wherein said surfactant is selected from non-ionic, anionic, cationic, zwitterionic surfactants or combinations thereof.

19. The composition of claim 18, wherein said surfactant is non-ionic surfactant.

20. The composition of claim 12, wherein said chemical bleaching agent is selected from oxidative bleaches, sodium peroxide, sodium hypochlorite, calcium hypochlorite and sodium dichloroisocyanurate or combinations thereof.

21. A method for the bleaching of textiles comprising:
a. providing: i) an ester source, ii) an acyl transferase, iii) hydrogen peroxide source and, iv) a textile in need of bleaching;
b. contacting said textile with said ester source, acyl transferase and hydrogen peroxide source for a length of time and under conditions suitable to permit the measurable whitening of the textile.

22. The method of claim 21 further comprising a one or more bioscouring enzyme.

23. The method of claim 22, wherein said ester source is an acetate ester.

24. The method of claim 23, wherein said ester source is selected from propylene glycol diacetate, ethylene glycol diacetate, triacetin, ethyl acetate and tributyrin.

25. The method of claim 21, wherein said acyl transferase exhibits a perhydrolysis to hydrolysis ratio that is greater than 1.

26. The method of claim 21, wherein the hydrogen peroxide source comprises a hydrogen peroxide generating oxidase and a suitable substrate.

27. The method of claim 26, wherein the oxidase is a carbohydrate oxidase.

28. The method of claim 21, wherein said suitable conditions comprise a pH of between about 5-11.

29. The method of claim 28, wherein the pH is between about 6 and 10.

30. The method of claim 28, wherein the pH is between about 6 and 8.

31. The method of claim 21, wherein said suitable conditions comprise a length of time of between about 2 minutes and 24 hours.

32. The method of claim 31, wherein the length of time is between about 15 minutes and 12 hours.

33. The method of claim 31, wherein the length of time is between about 30 minutes and 6 hours.

34. The method of claim 21, wherein said suitable conditions comprises a temperature of between about 15° C. and 95° C.

35. The method of claim 34, wherein said suitable conditions comprises a temperature of between about 24° C. and 60° C.

36. The method of claim 34, wherein said suitable conditions comprises a temperature of between about 30° C. and 50° C.

37. The method of claim 21, wherein said hydrogen peroxide is at a concentration of between about 100 ppm to 5000 ppm.

38. The method of claim 21, wherein said hydrogen peroxide is at a concentration of between about 500 ppm to 4000 ppm.

39. The method of claim 21, wherein said hydrogen peroxide is at a concentration of between about 1000 ppm to 3000 ppm.

40. The method of claim 21, where said acyl transferase is at a concentration of between about 0.005 ppm to 100 ppm.

41. The method of claim 21, where said acyl transferase is at a concentration of between about 0.01 to 50 ppm.

42. The method of claim 21, where said acyl transferase is at a concentration of between 0.05 to 10 ppm.

43. The method of claim 21, wherein said ester source is at a concentration of between about 100 ppm to 10,000 ppm.

44. The method of claim 21, wherein said ester source is at a concentration of between about 1000 ppm to 5000 ppm.

45. The method of claim 21, wherein said ester source is at a concentration of between about 2000 ppm to 4000 ppm.

46. A method for the treatment of textiles comprising:
a. providing: i) a one-step textile processing composition and ii) a textile in need of processing;
b. contacting said textile with said one-step textile processing composition, for a length of time and under conditions sufficient to permit desizing, scouring and bleaching of the textile.

47. The method of claim 46, wherein the one-step textile processing composition comprises i) one or more bioscouring enzymes and ii) one or more enzymatic bleaching system.

48. The method of claim 47, further comprising one or more desizing enzymes.

49. The method of claim 47, wherein the enzymatic bleaching system comprises an acyl transferase, an ester source and a hydrogen peroxide source.

50. The method of claim 49, wherein the hydrogen peroxide source is comprises a hydrogen peroxide generating oxidase and a suitable substrate.

51. The method of claim 50, wherein the oxidase is carbohydrate oxidase.

52. The method of claim 47, wherein said bioscouring enzyme is selected from a group consisting of pectinases, cutinases, proteases, cellulase, hemicellulase and lipases.

53. The method of claim 52, wherein said bioscouring enzyme is pectate lyase and/or combination of pectate lyase and other enzymes such as cutinases, cellulases, proteases, lipases, and hemicellulases.

54. The method of claim 48, wherein said desizing enzyme is selected from a group consisting of amylases, cellulases and mannanases.

55. The method of claim 54, wherein said desizing enzyme is β-amylase.

56. The method of claim 47, further comprising auxiliary components selected from surfactants, emulsifiers, chelating agents, dispersants, and/or stabilizers.

57. The method of claim 56, wherein said surfactant is non-ionic surfactant

58. The method of claim 47, wherein said enzymatic bleaching system generates a bleaching agent, further wherein said bleaching agent is peracetic acid generated by the perhydrolyzation of acetate ester groups in the presence of hydrogen peroxide and which is catalyzed by acyl transferase.

59. The method of claim 47, wherein the one-step composition further comprises a chemical bleaching agent selected from oxidative bleaches, sodium peroxide, sodium hypochlorite, calcium hypochlorite and sodium dichloroisocyanurate or combinations thereof.

60. The method of claim 46, wherein said textile is selected from the group consisting of a cellulosic, cellulosic-containing and non-cellulosic textiles.

61. The method of claim 60, wherein said cellulosic or cellulosic-containing textiles comprises cotton.

62. The method of claim 46, wherein said conditions sufficient to permit scouring and bleaching of said textile are a temperature of between about 15 and 95° C. and pH of between about 5 and 11 for a time of between about 2 minutes and 24 hours.

63. The method of claim 46, wherein said conditions sufficient to permit desizing, scouring and bleaching of said textile are a temperature of between about 15 and 95° C. and pH of between about 5 and 11 for a time of between about 2 minutes and 24 hours.
